(19) United States
(12) Patent Application Publication
(10) Pub. No.: US 2007/0283161 A1
(43) Pub. Date: Dec. 6, 2007

(54) System and method for generating verifiable device user passwords

(75) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/447,400

(22) Filed: Jun. 6, 2006

(51) Int. Cl. H04L 9/00

(52) U.S. Cl. 713/183

(57) ABSTRACT

The subject application is directed to a system and method for generating verifiable device user passwords. More particularly, the subject application is directed to a system and method for authenticating a document processing device with a client device without either device possessing any previous authentication certificate or information.

### BACKGROUND OF THE INVENTION

The subject application is directed to a system and method for generating verifiable device user passwords. More particularly, the subject application is directed to a system and method for authenticating a document processing device with a client device without either device possessing any previous authentication certificate or information.

Typically, a user of a multifunction peripheral device that is part of a networked environment will need to be registered to use such device before the user can initiate document processing operations on the device. In order to use a shared peripheral, secure systems frequently rely on pre-installed certificate authority files.

In a typical certificate authority system, a public key certificate is issued that states that the embedded public key belongs to the person, organization, computing device, or other entity reflected in the certificate. Presence of a certificate allows for identity verification and ensures that the key is associated with an identified entity.

If a certificate authority process is compromised, then communications may lose confidentiality, including communication of messages or electronic documents. In addition to security risks associated with compromised certificates, legal consequences may result in the event of a security breach. For example, legal documents may be denied enforceability in the event that an invalid certificate is present. It is desirable to have a system that supplies certificate authorization to users in a secure fashion, and which does not require that one be preassigned.

The subject application overcomes the above noted problems and provides a system and method for generating verifiable device user passwords.

### SUMMARY OF THE INVENTION

In accordance with the subject application, there is provided a system and method for generating verifiable device user passwords.

Further, in accordance with the subject application, there is provided a system and method for authenticating a document processing device with a client device without either device possessing any previous authentication certificate or information.

Still further, in accordance with the subject application, there is provided a system for generating verifiable device user passwords, wherein the system includes a processing device. The document processing device includes means adapted for obtaining first random string data and storage means associated with the processing device adapted for storing key data having a public key portion and a private key portion. The document processing device further includes means adapted for generating second random string data in accordance with the private key portion and means adapted for generating device hash data in accordance with performance of a hashing function on the public key portion. The document processing device also comprises means adapted for generating password data in accordance with the first random string, the second random string, and the hash data and output means adapted for outputting a first portion of the password data.

In one embodiment, the system also includes a client device in networked data communication with the processing device. The client device comprises means adapted for receiving the first portion of the password data from the processing device and means adapted for receiving the public key portion from the processing device. The client device further comprises means adapted for verifying the hash data in accordance with performance of a hashing function on the public key portion and comparison means adapted for comparing the hash data with the received first portion of the password data. The client device also includes certificate request generation means adapted for generating a certificate request for the client device in accordance with an output of the comparison means, wherein such certificate request includes the first portion of the password data and user identification data and output means adapted for outputting the certificate request to the processing device.

In another embodiment, the processing device further includes means adapted for receiving the certificate request from the client device and certificate comparison means adapted for comparing the portion of the password data included in the received certificate request with the portion of password data previously communicated via the output means. The processing device also includes means adapted for generating a certificate in accordance with an output of the certificate comparison means, the certificate including an extension including a second portion of the password data unique to the first portion and means adapted for communicating the generated certificate to the client device.

In yet another embodiment, the client device further comprises means adapted for receiving the certificate and means adapted for performing a hashing function on data representative of the first random string data to form verification data. The client device also includes verification means adapted for comparing the received certificate with the verification data and means adapted for authenticating the client device with the processing device in accordance with an output of the verification means.

In a preferred embodiment, the processing device includes a multi-function document processor and the client device includes a workstation in networked data communication therewith. The system also includes means adapted for transmitting at least one electronic document from an authenticated client device to the processing device and means adapted for receiving data representative of at least one requested document processing operation to be performed on the at least one electronic document by the processing device. The system further includes means adapted for commencing the at least one requested document processing operation on each electronic document received by the processing device.

Preferably, the processing device includes a random number generator adapted for generating the first random string data. Also, preferably, the user data includes at least one of a user identifier, network address, and electronic mail address associated with a user.

Still further, in accordance with the subject application, there is provided a method for generating verifiable device user passwords in accordance with the above described system.

Still other advantages, aspects and features of the subject application will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall system diagram of the system for generating verifiable device user passwords according to the subject application;

FIG. 2 is a block diagram illustrating the operation of the system for generating verifiable device user passwords according to the subject application;

FIG. 3 is a flowchart illustrating the method for generating verifiable device user passwords from the processing device perspective; and

FIG. 4 is a flowchart illustrating the method for generating verifiable device user passwords from the client device perspective according to the subject application.

### DETAILED DESCRIPTION OF THE PREFERRED EMBODIMENT

The subject application is directed to a system and method for generating verifiable device user passwords. In particular, the subject application is directed to a system and method for authenticating a document processing device with a client device without either device possessing any previous authentication certificate or information.

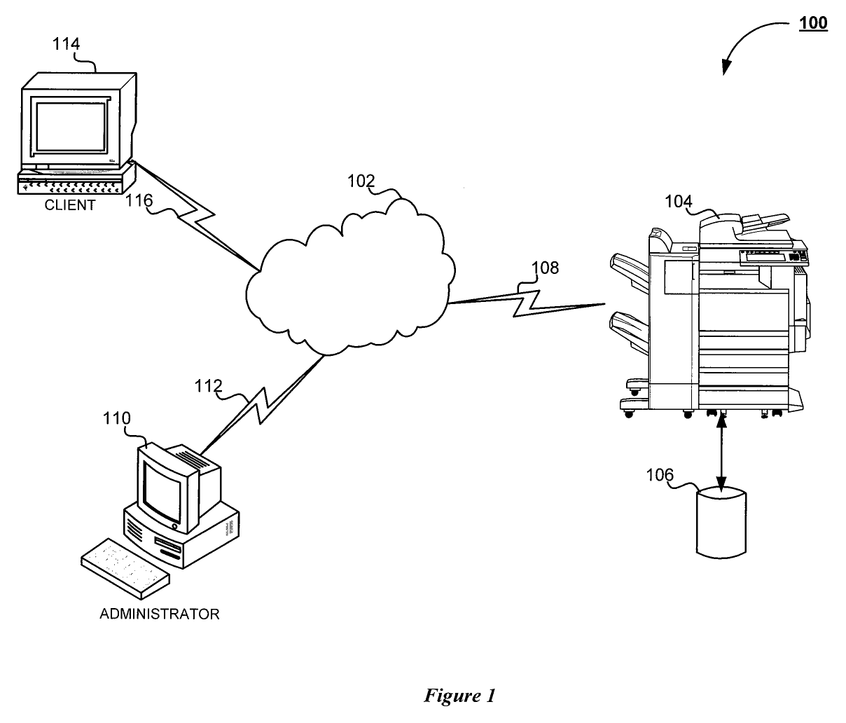

Turning now to FIG. 1, there is shown an overall diagram of the system 100 for generating verifiable device user passwords in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a personal area network, a wide area network, a local area network, a virtual local area network, an intranet, the Internet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11 (x), Ethernet, or other wireless or wire-based data communication mechanisms.

The system 100 depicted in FIG. 1 further incorporates at least one document processing device 104, represented as a multifunction peripheral device, suitably adapted to perform a variety of document processing operations. The skilled artisan will understand that such document processing operations include, for example and without limitation, copying, scanning, electronic mail, document management, facsimile, printing, and the like. Suitable commercially available document processing devices include, but are not limited to, the Toshiba e-Studio Series Controller. In accordance with one aspect of the subject application, the document processing device 104 is suitably adapted to function as a certificate authority, capable of generating and issuing certificates to one or more electronic devices resident on the computer network 102. In this embodiment, the document processing device 104 generates independent random string data seeded with a device 104 specific value (current time, number of pages printed, toner level remaining, or the like), generates string data seeded with a private symmetric key associated with the document processing device 104, and performs hashing operations on a public asymmetric key associated with the document processing device 104. In such an embodiment, the document processing device 104 is further adapted to employ a delimiter resulting in a concatenation of the values of the first random string value, the second random string value, and the hash value. As will be appreciated by those skilled in the art, the concatenated values, which together form password data, correspond individually to extension parts, explained more fully below, that are used in accordance with the registration methodologies of the subject application. The preceding descriptions of the capabilities of the document processing device 104 will be explained in greater detail below.

In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the present invention, the document processing device 104 further includes an associated user-interface, such as a touch-screen interface, LCD display, or the like, via which an associated user is able to interact directly with the document processing device 104. Preferably, the document processing device 104 is communicatively coupled to the computer network via a suitable communications link 108. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

Communicatively coupled to the document processing device 104 is a data storage device 106. In accordance with the preferred embodiment of the subject application, the data storage device 106 is any mass storage device known in the art including, for example and without limitation, magnetic storage drives, a hard disk drive, optical storage devices, flash memory devices, or any suitable combination thereof. In the preferred embodiment, the data storage device 106 is suitably adapted to store encryption data, concatenation values, user identification data, such as, for example and without limitation, user IDs, electronic mail addresses, IP addresses, and the like. Preferably, the concatenated values, i.e., password data, are stored in association with the user identification data, thereby enabling cross-referencing therebetween. It will be appreciated by those skilled in the art that while illustrated in FIG. 1 as being a separate component of the system 100, the data storage device 106 is capable of being implemented as internal storage of the document processing device 104, such as, for example and without limitation, an internal hard disk drive, or the like.

FIG. 1 further illustrates an administrator device 110, in data communication with the computer network 102 via a communications link 112. It will be appreciated by those skilled in the art that the use of the administrator device 110 is for example purposes only, and a network or system administrator is equally capable of functioning in accordance with the subject application. The use of the administrator device 110 is made solely to avoid confusion between the user associated with the client device 114, as shown in FIG. 1, having non-administrative or no access rights to the computer network 102, and the administrative user (represented by the device 110) having administrative or total access rights to the computer network 102. In accordance with the use of the administrator device 110 as representative of an individual having administrative rights and controls over devices resident on the computer network 102, the administrator device 110 is suitably adapted to perform a variety of tasks, as will be appreciated by those skilled in the art. For example, the administrator device 110 is capable, upon the request of a new user, of issuing a first portion of the password data to the user. The communications link 112 is any suitable data communications channel known in the art including, for example and without limitation, 802.11(x), infrared, Bluetooth, a proprietary communications network, the public switched telephone network, optical, or any other suitable wire-based or wireless data transmission means known in the art.

The skilled artisan will appreciate that the system 100 of FIG. 1 further includes at least one client device 114, communicatively coupled to the computer network 102 via a communications link 116. It will be appreciated by those skilled in the art that the client device 114 is depicted in FIG. 1 as a workstation for illustration purposes only. As the skilled artisan will understand, the client device 114 shown in FIG. 1 is representative of any personal computing device known in the art, including, for example and without limitation, a laptop computer, a personal computer, a personal data assistant, a web-enabled cellular telephone, a smart phone, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

In operation, from the document processing device side of the system 100, the document processing device 104 first stores a public/private key pair in local storage, i.e., the data storage device 106. Preferably, the public/private key pair is randomly generated via a random number generator or any other suitable means known in the art. In accordance with one embodiment of the subject application, the public/private key pair is generated by the administrator device 110 and transmitted via a secure communications channel to the document processing device 104. User data representative of a user associated with the client device 114 is received via any suitable means indicating the desire to establish a trusted relationship between the client device 114 and the document processing device 104. In accordance with one embodiment of the subject application, the user data is capable of being originated by the administrator device 110 and submitted to the document processing device 104 via the computer network 102. Irrespective of the manner in which it was received, the user data is stored in the data storage device 106 communicatively coupled to the document processing device 104. The document processing device 104 then generates a first random string (extension Part A) via any suitable means known in the art. The document processing device 104 then uses the private key portion of the key pair as a seed for the generation of a second random string (extension Part B). The document processing device 104 then performs a hashing operation on the public key portion of the key pair, thereby generating hash data (extension Part C). The first random string (Part A), the second random string (Part B), and the hash data (Part C) are then used to generate password data, which is then stored in the data storage device 106 communicatively coupled to the document processing device 104, such that the password data is associated in the storage device 106 with the received user data. It will be understood by those skilled in the art that the password data is a concatenation of Part A, Part B, and Part C, a portion of which data is given, by the administrator 110 to the user associated with the client device 114. The user then inputs the received portion of the password data into the client device 114 via any suitable means. In an alternative embodiment, the portion of the password data is transmitted directly from the administrator 110 to the client device 114 via the computer network 102.

The document processing device 104 then receives a certificate request from the client device 114 containing an extension Part B and compares the extension Part B from the request to the stored Part B associated with the user data to determine if the two sets of data match. When the data does not match, the document processing device 104 denies the certificate request from the client device 114. When the data matches, the document processing device 104 generates a certificate including an extension Part A, which is transmitted to the client device 114 via the computer network 102. The document processing device 104 then receives a document processing request from the client device 114 corresponding to the performance of a selected document processing operation. As a trusted relationship exists between the document processing device 104 and the client device 114, the operation is thereafter performed.

When viewed from the client side of the system 100, the client device 114 first receives a portion of the password data from the administrator 110. In accordance with one embodiment of the subject application, the first portion of the password data is received from the administrator device 110 prior to the initial interaction between the client device 114 and the document processing device 104. The public key associated with the document processing device 104 is then retrieved by the client device 114 and a hashing operation is performed on the public key to generate hash data at the client device 114. The generated hash data is then compared to the received Part C of the first portion of the password data to determine whether the password data is verifiable. When it is determined that the data matches, the client device 114 registers with the document processing device 104 by submitting a certificate request including the extension Part B from the first portion of the password data. The skilled artisan will appreciate that any registration methodology known in the art is capable of being employed by the subject application during the certificate request transmission.

The client device 114 then receives a certificate from the document processing device 104 and retrieves the first random string data (an extension Part A) therefrom. The client device 114 then performs a hashing operation on the first random string (extension Part A), thereby generating verification data. The generated verification data is then compared to Part A of the certificate to determine if the data matches. When the data does not match, the user associated with the client device 114 is notified of the invalidity of the certificate and the operation terminates. When the verification data and Part A of the certificate match, the client device 114 authenticates with the document processing device 104 via any suitable means. Upon authentication, the client device 114 is able to submit document processing requests to the document processing device 104. In the preferred embodiments of the subject application, communication during the registration/authentication processes described above and hereinafter is advantageously accomplished using a secure communications channel among the client device 114, the administrator device 110, and the document processing device 104. The skilled artisan will appreciate that the secure communications channel is implemented using data security protocols, such as web security protocols, e.g., secure socket layer (SSL) protocol, and the like.

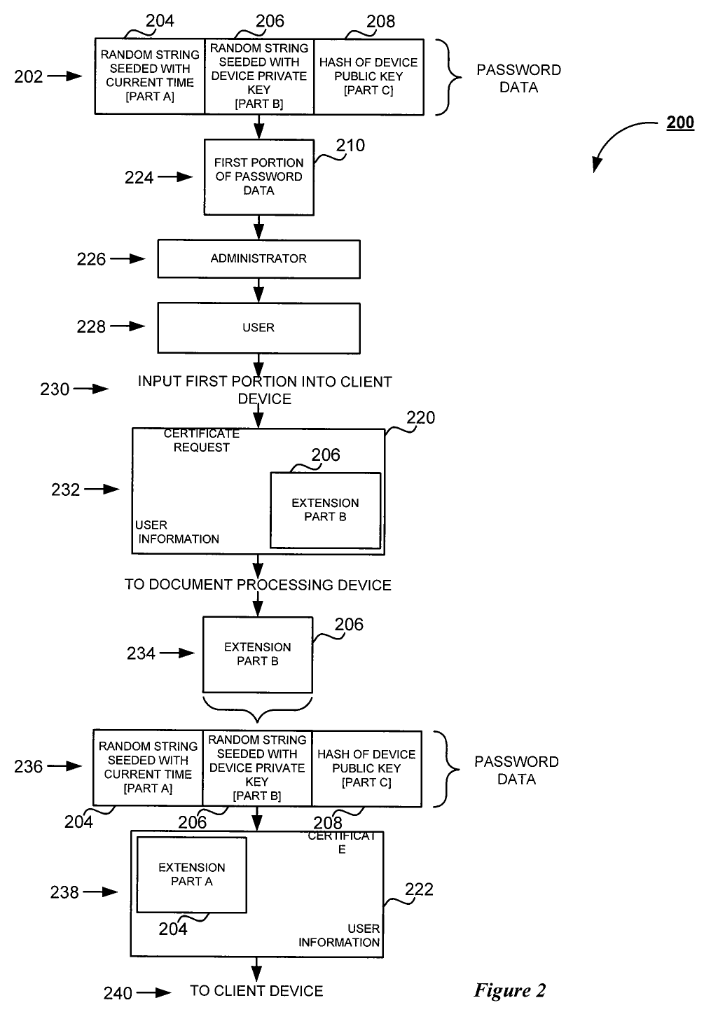

The operation of the system 100 illustrated in FIG. 1 will better be understood in conjunction with the block diagram of FIG. 2. Referring now to FIG. 2, there is shown a block diagram 200 illustrating the operation of the system 100 in accordance with the subject application. As shown in FIG. 2, the document processing device 104 generates password data 202 comprising the concatenated values of the first random string (extension Part A) 204, the second random string (extension Part B), and the hash value of the public key (extension Part C) 208. The document processing device 104 then transmits at 224 a first portion 210 of the password data 202 to the administrator 110 at 226. It will be appreciated by those skilled in the art that the first portion 210 is then passed on to the user at 228 via any suitable means of communication including, for example and without limitation, a portable storage medium, an electronic message attachment, a hard copy, or the like.

The user then inputs the first portion 210 into the client device 114 at 230. The client device 114 then generates at 232 a certificate request 220 including extension Part B 206, which was included in the first portion 210. It will be appreciated by the skilled artisan that prior to generation of the certificate request 220, the client device 114 first retrieves the public key associated with the document processing device 104 and performs a hash operation thereon. The hashed public key is then compared to Part C 208, which was included in the first portion 210. Thus, upon a successful comparison, the certificate request 220 is generated. The certificate request 220 is then sent to the document processing device 104, which compares the received Part B 206 at 234 to the password data 202 at 236. This comparison is used to verify that the user, associated with client device 114, is the user to whom the password data 202 was designated. Once Part B 206 of the received certificate request is verified against the stored Part B 206 of the password data 202, the document processing device 104 generates a certificate 222 at 238, including the extension Part A 204. This certificate 222 is then sent to the client device 114 at 240, whereupon the client device 114 performs a hashing operation on the received extension Part A to generate verification data. The verification data is then compared to the certificate 222 to provide verification of the document processing device 104 to the client device 114, thereby enabling the client device 114 to submit document processing requests to the document processing device 104.

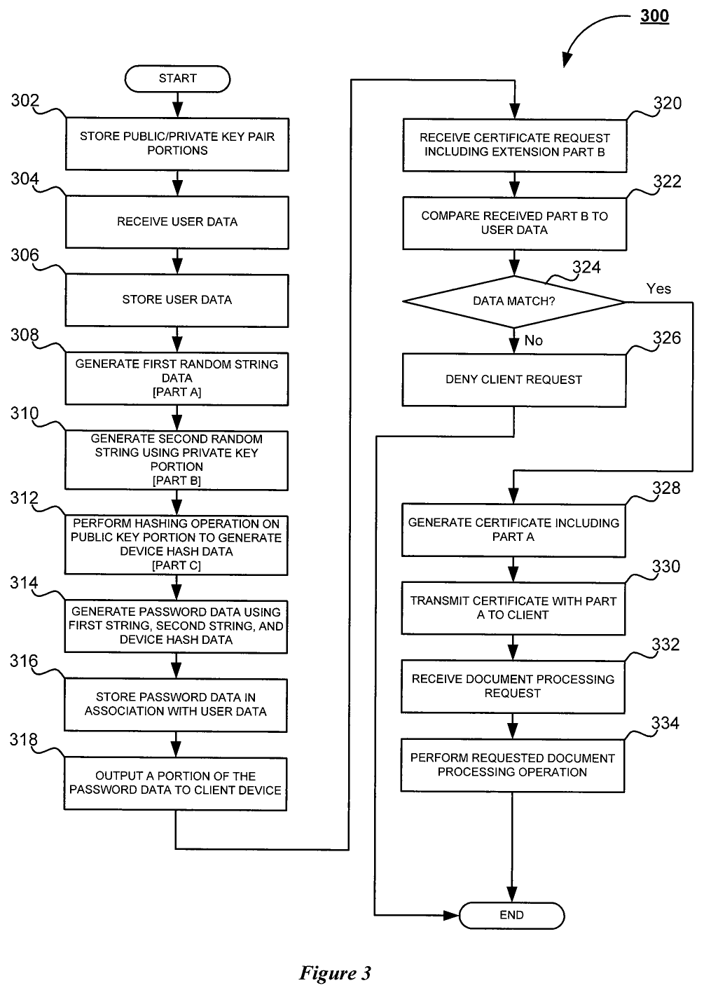

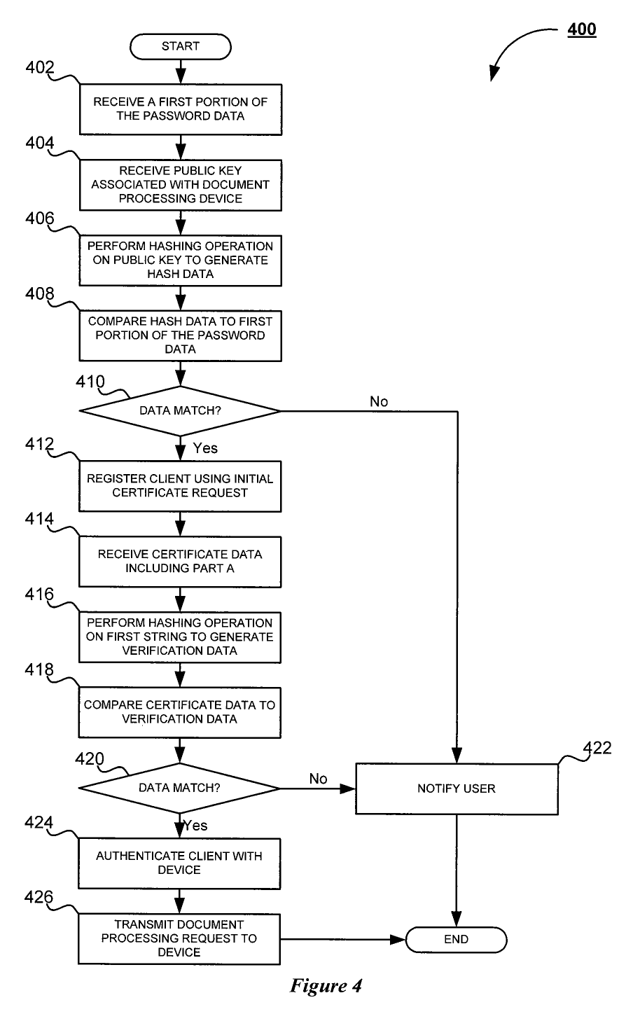

The system 100 of FIG. 1 and the block diagram 200 of FIG. 2 will better be understood when viewed in conjunction with the methodologies illustrated in FIGS. 3 and 4. Referring to FIG. 3, there is shown a flowchart 300 illustrating a methodology for generating verifiable device user passwords from the processing device perspective in accordance with the subject application. Beginning at step 302, a public/private key pair is stored in the data storage device 106 communicatively coupled to the document processing device 104. It will be understood by those skilled in the art that the key pair is capable of being generated by the administrator device 110 and securely transmitted to the document processing device 104 via a secure communications channel. Preferably, the document processing device 104 includes the functionality to generate such encryption key pairs internally, whereupon the generated key pairs are stored on the local storage device 106. The document processing device 104 then receives, at step 304, user data representative of a user associated with the client device 114. In accordance with the preferred embodiment of the subject application, the user data includes, for example and without limitation, a user ID, an electronic mail address, an IP address, or other identifying data, as will be understood by those skilled in the art. It will be understood by those skilled in the art that the user data is advantageously received from the administrator device 110, or the like.

The received user data is then stored in the local storage device 106, communicatively coupled to the document processing device 104 at step 306. Next, first random string data, also referred to herein as extension Part A 204, is obtained by the document processing device 104 via any suitable means known in the art at step 308. Preferably, the document processing device 104 generates the first random string data, extension Part A 204, using methodologies that will be apparent to those of ordinary skill in the art. In accordance with one embodiment of the subject application, extension Part A 204 is generated using a seed corresponding to the current time of the document processing device 104. The skilled artisan will appreciate that other seeds are capable of being used in generating random string data and the subject application is not limited to the methods described herein. A second random string data, also referenced hereinafter as extension Part B 206, is then generated by the document processing device at step 310 using the private key portion of the public/private encryption key pair associated with the document processing device 104. A hashing operation is then performed on the public key portion of the public/private encryption key pair at step 312, thereby generating device hash data, also referenced hereinafter as extension Part C 208. Thereafter, the document processing device 104 using the first string data (extension Part A 204), the second string data (extension Part B 206), and the device hash data (extension Part C 208), generates password data 202 at step 314. That is, the two string values and the third value of the device hash data are concatenated using a delimiter. The password data 202 is then stored locally in the data storage device 106 in association with the user data at step 316. A first portion 210 of the password data 202 is then transmitted, via a secure communications channel, to the client device 114 at step 318.

Thereafter, the document processing device 104 receives a certificate request 220 from the client device 114, including extension Part B 206, at step 320. The certificate request 220 is then compared to the user data at step 322 to assist in the verification that the user to whom the first portion 210 of the password data 202 was sent is the user submitting the certificate request 220. A determination is then made at step 324 to determine the validity of the received certificate request 220, i.e., that the received data matches the stored user data, i.e., the extension Part B 206 stored locally in the data storage device 106 associated with the user data. When the user data and extension Part B 206 of the certificate request 220 are inconsistent, the document processing device 104 denies the registration of the requesting client device 114 at step 326, thereby terminating the operation of the methodology of the flowchart 300 embodied in FIG. 3. When the document processing device 104 has determined at step 324 that extension Part B 206 of the certificate request 220 is valid, flow proceeds to step 328, whereupon a certificate 222 is generated. Preferably, the certificate includes data representative of the result of a hashing operation performed on the first string data, i.e., extension Part A 204.

The certificate 222 is then transmitted, via a secure communications channel, to the requesting client device 114 at step 330. Thereafter, the document processing device 104 receives a document processing request from the client device 114 at step 332. It will be appreciated by those skilled in the art that the client device 104 has been authenticated as of step 330 from the point of view of the document processing device 104, thereby rendering the document processing device 104 capable of performing submitted document processing operations. Accordingly, the document processing device 104 then performs the requested document processing operation at step 334.

With reference now to FIG. 4, there is shown a flowchart 400 illustrating a methodology for generating verifiable device user passwords from the client device perspective in accordance with the subject application. The method begins at step 402 with the receipt by the client device 114 of a first portion 210 of password data 202. Preferably the first portion 210 of the password data 202 is received from the document processing device 104 via a secure communications channel, however the skilled artisan will appreciate that the administrator device 110 is also capable of providing the user associated with the client device 114 with the password data. At step 404, the client device 114 receives the document processing device public key from the document processing device 104, the administrator device 110, or the like.

A hashing operation is then performed on the retrieved public key, thereby generating hash data at step 406. At step 408, the generated hash data is compared to extension Part C 208 of the first portion 210 of the password data 202 to verify that the document processing device 104 sending the first portion 210 of the password data 202 is the document processing device to which is attributed the origination of first portion 210 of the password data 202. A determination is then made at step 410 whether extension Part C 208 of the first portion 210 of the password data 202 and the hash data match. When it is determined that the two sets of data do not match, the document processing device 104 cannot be verified by the client device 114, and the user associated with the client device 114 is notified of the problem. When a match is found between the two data sets, flow proceeds to step 412, whereupon the client device 114 attempts registration with the document processing device 104 by sending a certificate request 220 inclusive of extension Part B 206 of the first portion 210 to the document processing device 104.

Upon successful registration with the document processing device 104, as indicated by the receipt at step 414 of a certificate 222 inclusive of extension Part A 204, the client device 114 proceeds to step 416. At step 416, the client device 114 performs a hashing operation on the first string data, thereby generating verification data. The verification data and extension Part A 204 of the certificate 222 are then compared at step 418, so as to verify that the certificate was not issued due to a mistake by the document processing device 104 and that the document processing device 104 does possess the entire issued password data. A determination is then made at step 420 whether extension Part A 204 of the certificate matches that of the verification data. When no match is determined at step 420, flow proceeds to step 422, whereupon the user is notified of inconsistencies and the operation terminates. When a match is determined by the client device 114 at step 420, flow proceeds to step 424, whereupon the client device 114 is authenticated with the document processing device 104, as will be understood by those skilled in the art. The client device 114 then transmits a document processing request to the document processing device 104 at step 426.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for generating verifiable device user passwords comprising:
a processing device including,
means adapted for obtaining first random string data;
storage means associated with the processing device adapted for storing key data having a public key portion and a private key portion;
means adapted for generating second random string data in accordance with the private key portion;
means adapted for generating device hash data in accordance with performance of a hashing function on the public key portion;
means adapted for generating password data in accordance with the first random string, the second random string, and the hash data; and
output means adapted for outputting a first portion of the password data.

2. The system for generating verifiable device user passwords of claim 1 further comprising:
a client device in networked data communication with the processing device including,
means adapted for receiving the first portion of the password data from the processing device;
means adapted for receiving the public key portion from the processing device;
means adapted for verifying the hash data in accordance with performance of a hashing function on the public key portion;
comparison means adapted for comparing the hash data with the received first portion of the password data;
certificate request generation means adapted for generating a certificate request for the client device in accordance with an output of the comparison means, wherein such certificate request includes the first portion of the password data and user identification data; and
output means adapted for outputting the certificate request to the processing device.

3. The system for generating verifiable device user passwords of claim 2 wherein the processing device further includes:
means adapted for receiving the certificate request from the client device;
certificate comparison means adapted for comparing the portion of the password data included in the received certificate request with the portion of password data previously communicated via the output means;
means adapted for generating a certificate in accordance with an output of the certificate comparison means, the certificate including an extension including a second portion of the password data unique to the first portion; and
means adapted for communicating the generated certificate to the client device.

4. The system for generating verifiable device user passwords of claim 3 wherein the client device further comprises:
means adapted for receiving the certificate;
means adapted for performing a hashing function on data representative of the first random string data to form verification data;
verification means adapted for comparing the received certificate with the verification data; and
means adapted for authenticating the client device with the processing device in accordance with an output of the verification means.

5. The system for generating verifiable device user passwords of claim 4 wherein the processing device includes a multi-function document processor and wherein the client device includes a workstation in networked data communication therewith, and further comprising:
means adapted for transmitting at least one electronic document from an authenticated client device to the processing device;
means adapted for receiving data representative of at least one requested document processing operation to be performed on the at least one electronic document by the processing device; and
means adapted for commencing the at least one requested document processing operation on each electronic document received by the processing device.

6. The system for generating verifiable device user passwords of claim 5 wherein the processing device includes a random number generator adapted for generating the first random string data.

7. The system for generating verifiable device user passwords of claim 6 wherein the user data includes at least one of a user identifier, network address, and electronic mail address associated with a user.

8. A method for generating verifiable device user passwords comprising the steps of:
receiving first random string data at an associated processing device;
storing key data having a public key portion and a private key portion at the processing device;
generating second random string data in accordance with the private key portion via the processing device;
generating device hash data in accordance with performance of a hashing function on the public key portion via the processing device;
generating password data in accordance with the first random string, the second random string, and the hash data via the processing device; and
outputting a first portion of the password data from the processing device.

9. The method for generating verifiable device user passwords of claim 8 further comprising the steps of:
receiving the first portion of the password data from the processing device at a client device in networked data communication with the processing device
receiving the public key portion from the processing device at the client device;
verifying the hash data in accordance with performance of a hashing function on the public key portion via the client device;
comparing the hash data with the received password data via the client device; and
generating a certificate request for the client device in accordance with an output of the step of comparing, wherein such certificate request includes the first portion of the password data and the user identification data; and
outputting the certificate request to the processing device.

10. The method for generating verifiable device user passwords of claim 9 further comprising the steps of:
receiving the certificate request from the client device at the processing device;
comparing the portion of the password data included in the received certificate request with the portion of password data previously communicated to the client device;
generating a certificate in accordance with an output of the step of comparing, the certificate including an extension including a second portion of the password data unique to the first portion; and
communicating the generated certificate to the client device.

11. The method for generating verifiable device user passwords of claim 10 further comprising the steps of:
receiving the certificate at the client device;
performing a hashing function on a data representative of the first random string data to form verification data via the client device;
comparing the received certificate with the verification data via the client device; and
authenticating the client device with the processing device in accordance with an output of the step of comparing the received certificate with the verification data.

12. The method for generating verifiable device user passwords of claim 11 wherein the processing device includes a multi-function document processor and wherein the client device includes a workstation in networked data communication therewith, and further comprising the steps of:
transmitting at least one electronic document from an authenticated client device to the processing device;
receiving data representative of at least one requested document processing operation to be performed on the at least one electronic document by the processing device; and
commencing the at least one requested document processing operation on each electronic document received by the processing device.

13. The method for generating verifiable device user passwords of claim 12 further comprising the step of generating the first random string data via the processing device.

14. The method for generating verifiable device user passwords of claim 13 wherein the user data includes at least one of a user identifier, network address, and electronic mail address associated with a user.

15. A computer-implemented method for generating verifiable device user passwords comprising the steps of:
receiving first random string data at an associated processing device;
storing key data having a public key portion and a private key portion at the processing device;
generating second random string data in accordance with the private key portion via the processing device;
generating device hash data in accordance with performance of a hashing function on the public key portion via the processing device;
generating password data in accordance with the first random string, the second random string, and the hash data via the processing device; and
outputting a first portion of the password data from the processing device.

16. The computer-implemented method for generating verifiable device user passwords of claim 15 further comprising the steps of:
receiving the first portion of the password data from the processing device at a client device in networked data communication with the processing device
receiving the public key portion from the processing device at the client device;
verifying the hash data in accordance with performance of a hashing function on the public key portion via the client device;
comparing the hash data with the received password data via the client device; and
generating a certificate request for the client device in accordance with an output of the step of comparing, wherein such certificate request includes the first portion of the password data and the user identification data; and
outputting the certificate request to the processing device.

17. The computer-implemented method for generating verifiable device user passwords of claim 16 further comprising the steps of:
receiving the certificate request from the client device at the processing device;
comparing the portion of the password data included in the received certificate request with the portion of password data previously communicated to the client device;
generating a certificate in accordance with an output of the step of comparing, the certificate including an extension including a second portion of the password data unique to the first portion; and
communicating the generated certificate to the client device.

18. The computer-implemented method for generating verifiable device user passwords of claim 17 further comprising the steps of:
receiving the certificate at the client device;
performing a hashing function on a data representative of the first random string data to form verification data via the client device;
comparing the received certificate with the verification data via the client device; and
authenticating the client device with the processing device in accordance with an output of the step of comparing the received certificate with the verification data.

19. The computer-implemented method for generating verifiable device user passwords of claim 18 wherein the processing device includes a multi-function document processor and wherein the client device includes a workstation in networked data communication therewith, and further comprising the steps of:
transmitting at least one electronic document from an authenticated client device to the processing device;
receiving data representative of at least one requested document processing operation to be performed on the at least one electronic document by the processing device; and
commencing the at least one requested document processing operation on each electronic document received by the processing device.

20. The computer-implemented method for generating verifiable device user passwords of claim 19 further comprising the step of generating the first random string data via the processing device and the user data includes at least one of a user identifier, network address, and electronic mail address associated with a user.
